(19) United States
(12) Patent Application Publication
(10) Pub. No.: US 2005/0042988 A1
(43) Pub. Date: Feb. 24, 2005

(54) Combined open and closed loop transmission diversity system

(75) Inventors: Conelis Hoek, (US); Stefan Russ, (US); Volker Braun, (US)

Correspondence Address: SUGHRUE MION, PLLC, 2100 Pennsylvania Avenue, NW, Washington, DC, 20037-3213, US

(73) Assignee: ALCATEL

(21) Appl. No.: 10/900,131

(22) Filed: Jul. 28, 2004

(30) Foreign Application Priority Data
Aug. 18, 2003 (EP) 03292038.1

(51) Int. Cl. H04B 1/00; H04B 7/00; H04B 1/02

(52) U.S. Cl. 455/69; 455/101

(57) ABSTRACT

A transmitting diversity system for wireless transmission of information to a receiver station comprising antenna means composed of a plurality of antenna groups, and each group consisting of a plurality of antennas; receiving means for receiving feedback information from the receiver station using a feedback channel for intra antenna group control; control means for controlling a phase and/or amplitude of a signal transmitted by the antenna means based on said feedback information; and an open-loop transmission diversity encoder for encoding of the signal to be transmitted to the receiver station by every antenna group. It also relates to a method for transmitting a wireless signal to a receiver station by means of a transmitting diversity system having at least four antennas, the antennas arranged in groups; and to a base station and a mobile station comprising such a transmitting diversity system.

### BACKGROUND OF THE INVENTION

The invention is based on a priority application EP 03292038.1 which is hereby incorporated by reference.

The present invention relates to the field of wireless mobile communication systems and, more particularly, to a combined open-/closed-loop transmitting diversity system used for said wireless mobile communications.

A wireless communication system commonly comprises a radio network with at least a base station and a plurality of mobile stations communicating with the network via the base station. It is also known that such wireless mobile communications suffer from four major impairments: path loss, multipath fading, inter-symbol interference (ISI) and co-channel interference.

Time and space “diversity techniques” have been applied to overcome fading. The space diversity technique makes use of multiple antennas for transmission and/or reception. In this case, “diversity gain” is provided at the receiver by transmission channels with low fading correlation between them, that is, in such case the probability that channel fades occur simultaneously for multiple antennas is low. In order to achieve low fading correlation between the antennas, a known antenna arrangement locates the antennas spatially apart from each other, typically about ten times or more the transmission wavelength. On the other hand, an alternative antenna arrangement for space diversity transmission and/or reception uses dual-polarized (also called cross-polarized) antennas, because the fading correlation between antennas with orthogonal polarization orientation is often low. This is also called “polarization diversity”.

Another known multiple antenna transmission technique, also known as “beam-forming”, provides “beam-forming gain” at the receiver by making use of spatial directivity, thus compensating for path loss to a certain extent and suppressing co-channel interference. Because high fading correlation between transmission channels is advantageous to achieve beam-forming gain, in a typical antenna arrangement the antennas are located sufficiently spatially close to each other, e.g. half of the transmission wavelength.

Further, the multiple antenna transmission techniques explained above (beam-forming or diversity) can be categorized into “closed-loop” transmission schemes, where the mobile stations feed back information regarding the use of the transmitting antennas back to the base station, and “open-loop” transmission schemes, where no such feedback occurs from mobile stations to the base station. For example, according to a “closed-loop” transmission “diversity” or “beam-forming” approach, the base station transmits a pilot signal through each antenna to the mobile station, then, the mobile station determines the magnitude and/or phase of the channels from each pilot signal, finds optimal weight values based on the magnitude and/or phase of the channels and sends these values back to the base station, which uses these weight values to adapt the transmission of data channels per antenna.

In the 3GPP specification TS 25.214, chapter 7, Release 99 version, for the Universal Mobile Telecommunications System (UMTS), closed-loop transmit diversity modes 1 and 2 for two antennas, are disclosed. Closed-loop Mode 1 feeds back only information for controlling the phase between the two antenna signal channels, whereas Closed-loop Mode 2 feeds back information for controlling the amplitudes as well as phases of the two antenna signals.

In general, there is a variety of “open loop” diversity transmission schemes, e.g. space-time block codes, space-time trellis codes, or space-time spreading, for use with two or more transmission antennas. Encoders using said schemes are well known in the art. In 3GPP specification TS 25.211 chapter 5.3.1.1, Release 99 version, an “open loop” diversity transmission scheme for two antennas, called Space Time Transmit Diversity (STTD), is disclosed. The STTD scheme uses a space time block code for the two transmission antennas. At the output of the STTD encoder, there are two signals to be transmitted via different antennas, both signals having a data rate equal to that of the encoder input signal. The output signals are encoded in an orthogonal way so as to provide full “diversity gain”.

European Patent EP 1 315 311, which is considered the closest state of the art, tries to combine “closed-loop” “beam-forming” and “diversity” techniques to obtain a “diversity transmission” technique for more than two antennas. A transmitting diversity communication device is disclosed which comprises antenna means composed of a plurality of antenna groups, each group consisting of a plurality of antennas located close to one another so that fading correlation between antennas is high, and the antenna groups are located apart from one another so that fading correlation between the antenna groups is low; and control means for receiving first control information for intra-group antenna control, with a low transfer rate and second control information for inter-antenna group control, with a high transfer rate that are transmitted from a mobile station, and controlling a phase and/or amplitude of a signal transmitted by the antenna means. In a preferred embodiment of said invention (FIG. 4 of said invention), a case where the number of antennas N=4 and the number of antenna groups M=2 is described.

However the above “pure” “closed loop” combination of “beamforming” gain and “diversity” gain solution still presents the following problems:
A. For antenna configurations with a large spacing between several antenna groups a significant gain is achieved for low mobile station speeds, but in case of high mobile station speeds the low correlation between the antenna elements causes the optimal weights W to change fast. The available capacity in the uplink feedback channel for the transfer of these weights can become then a bottleneck, and if the feedback channel bandwidth is not sufficiently wide, communication performance degrades due to poor adaptability to channel variations, resulting in a reduced or even negative gain.
B. In case more uplink feedback channel capacity is arranged to solve the problem stated in A, still the large amount of feedback information needed from the mobile station can cause interference to other users.

So, although contributions are known which combine “beam-forming” and “diversity” techniques, at present time, these are confined to “pure” “open-loop” or “closed-loop” transmission diversity systems. Often, these prior art solutions have not shown a satisfactory performance for more than 2 antennas. For example, a “pure” “open-loop” “diversity” system with 4 transmission antenna elements would also present the following fundamental problems:
A. Requires a large spacing between the antennas, resulting in big antenna constellation sizes.
B. The additional gains that are achieved compared to an “open loop” “diversity” systems with 2 transmission antenna elements are low.
C. There are no perfect orthogonal space-time block codes for 4 transmission antenna elements.
D. For low mobile station speeds the achievable gains are lower than with “closed-loop” methods.

### SUMMARY OF THE INVENTION

The object of the invention is to overcome the main disadvantages of the above cited state of the art systems by developing a “combined” “open-/closed-loop” transmission diversity system providing a significant gain to the downlink/uplink wireless transmission capacity, which is almost independent of the mobile station speed. The system will also benefit simultaneously from both “diversity” gain and “beam-forming” gain.

The object is achieved according to the invention by transmitting diversity system for wireless transmission of information to a receiver station comprising antenna means composed of a plurality of antenna groups, and each group consisting of a plurality of antennas; receiving means for receiving feedback information from the receiving station using a feedback channel for intra antenna group control; control means for controlling a phase and/or amplitude of a signal transmitted by the antenna means based on said feedback information; and an open-loop transmission diversity encoder for encoding of the signal to be transmitted to the receiver station by every antenna group.

The object is also achieved by
a method for wireless transmission of a signal to a receiver station by means of a transmitting diversity system having at least four antennas arranged in groups, comprising the steps of:
   encoding a signal to be transmitted by means of an “open-loop diversity” encoder.
   transmitting the encoded signals which come out of the encoder by means of antenna groups using a “closed-loop beam-forming” technique; and
a base station or a mobile station comprising a transmitting diversity system according to the invention.

The system here described avoids the necessity for the development of a method to select the optimal transmission diversity mode in the base station depending on the mobile station speed. Further, it allows additional “diversity” gain in the uplink direction, and it allows the reuse of algorithms for “open-loop” Space Time Transmission Diversity (STTD) and “closed-loop diversity/beam-forming” already existing in the mobile station and in the base station with very low adaptation effort.

Advantageous configurations of the invention emerge from the dependent claims, the following description and the drawings.

### BRIEF DESCRIPTION OF THE DRAWINGS

An embodiment example of the invention is now explained with the aid of FIGS. 1 to 3.

FIG. 1 A,B,C shows different state of the art antenna array arrangements.

FIG. 2 shows a base station with a combined beam-forming/diversity scheme with four transmission diversity antennas.

FIG. 3 shows an example of a combined open-/closed-loop transmission diversity system according to the invention with a four antenna arrangement.

FIG. 4 A,B shows an example of two possible implementations of the four antenna arrangement of the open-/closed-loop transmission diversity system according to the invention.

### DETAILED DESCRIPTION OF THE DRAWINGS

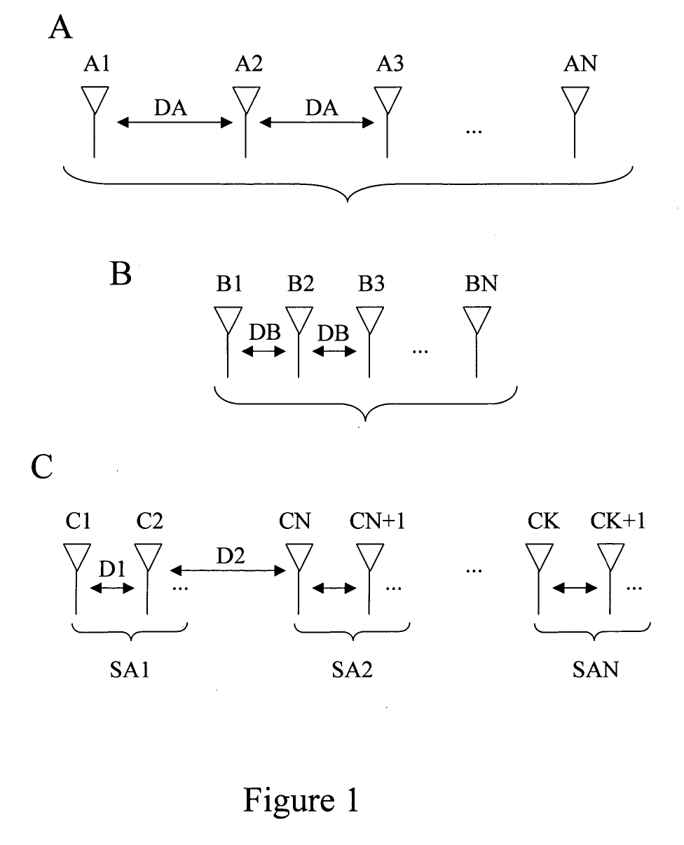

FIG. 1A shows a typical “diversity” antenna arrangement where the antenna A1 to AN spacing DA is usually required to be large enough, e.g., ten times the transmission wavelength in order to obtain low-correlation/independent fading channels. The antennas A1 to AN transmit via independent uncorrelated channels to the mobile station.

FIG. 1B shows a typical “beam-forming” antenna arrangement where the antenna B1 to BN spacing DB is usually required to be small enough, e.g. half of the transmission wavelength, in order to achieve spatial directivity. The antennas B1 to BN transmit via strongly correlated channels to the mobile station.

While FIGS. 1 A, B show a single antenna array arrangement, FIG. 1C shows a “combined” “diversity/beam-forming” antenna arrangement where a plurality of antenna groups or sub-arrays SA1 to SAN are spaced D2 apart from one another so that fading correlation between the antenna groups SA1 to SAN is low, and each group consisting of a plurality of antennas spaced D1 close to one another so that fading correlation between antennas is high.

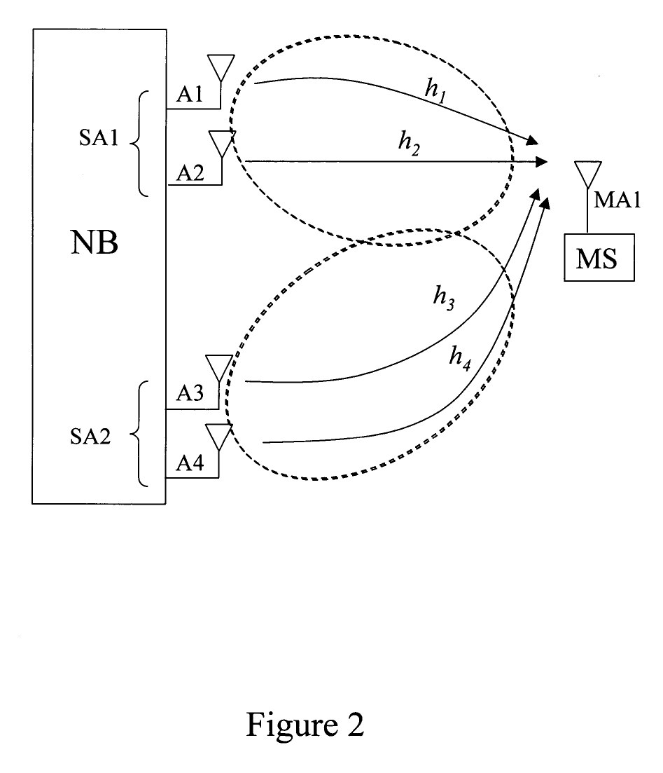

FIG. 2 shows a base station NB with a combined beam-forming/diversity antenna scheme with four transmission diversity antennas A1 to A4 arranged in two sub-arrays SA1 and SA2 or groups, each comprising two antennas. Such antenna configuration is also called here a 2×2 antenna arrangement. Each antenna transmits information to a mobile station MS, having reception antenna means MA1, through their respective transmission physical channels h1 to h4.

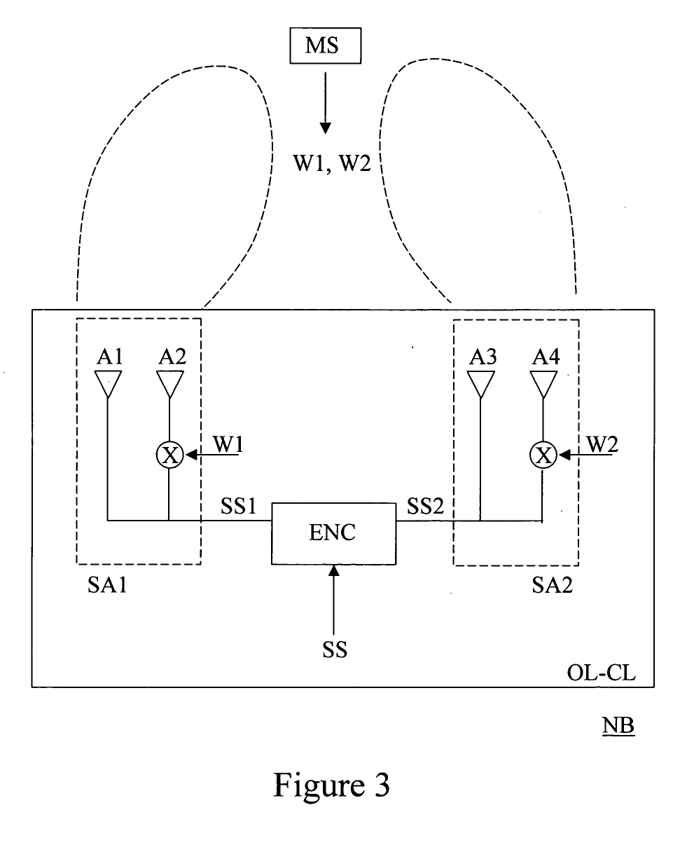

FIG. 3 shows an example of a combined open-/closed-loop transmission diversity system OL-CL according to the invention with a four (2×2) antenna arrangement.

In the example of the figure, according to the invention, a “closed-loop beam-forming” technique is used for intra-group antenna diversity transmission and an “open-loop diversity” technique is used for inter-group diversity transmission.

The transmission data signal, intended to be transmitted to the mobile station MS, is passed in the form of a symbol stream data signal SS to an “open loop” space time transmit diversity (STTD) encoder ENC which is in charge of modulating said symbols using a space-time block code and generating two different encoded symbol stream signals SS1 and SS2 to be transmitted by the two antenna pairs or sub-arrays SA1 and SA2 simultaneously. Since the correlation between sub-arrays is low, “diversity gain” is achieved by means of the open loop diversity component. Then, a “closed-loop” method, for example Closed-loop Mode 1 or Closed-loop Mode 2, is used in each antenna pair SA1 and SA2 by applying a complex number weight W1 and W2 to one of the antennas A2 and A4 of the antenna pair. The feedback values W1 and W2 received from the mobile station for the two sub-arrays SA1 and SA2 are multiplexed, this reduces the weight update rate by a factor of two, given a fixed capacity of the feedback channel, but this reduction has almost no influence since the antennas of a sub-array are strongly correlated and the optimal weights are mainly dependent on the direction of the mobile and are changing slowly.

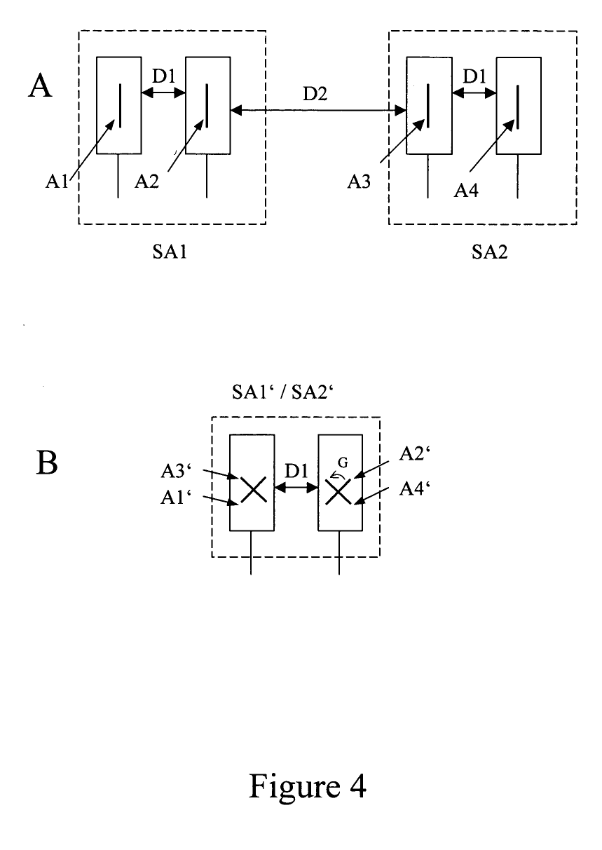

FIG. 4 A,B shows an example of two possible implementations of the preferred four antenna arrangement (2×2) of the open-/closed-loop transmission diversity system OL-CL shown in FIG. 3, according to the invention.

FIG. 4 A shows a space diversity configuration comprising four vertical-polarized antennas A1 to A4 arranged in two groups SA1 and SA2. The antennas inside the groups are spaced apart half a wavelength D1 so that the correlation between the two antennas of the antenna pair is high; and the antenna groups SA1 and SA2 are spaced about ten-to-twenty times a wavelength D2 so that the correlation between the antenna pairs is low.

FIG. 4 B shows a cross-polarization configuration comprising four cross-polarized antennas A1′ to A4′ arranged in two groups SA1′ and SA2′, antennas A1′ and A2′ belonging to antenna group SA1′ and antennas A3′ and A4′ belonging to antenna group SA2′. The antennas inside the groups are spaced apart half a wavelength D1 so that the correlation between the two antennas is high; and the polarization of the antenna groups SA1′ and SA2′ are orientated an angle G of about 90 degrees apart so that the correlation between the antenna pairs is low.

The current invention concepts here explained can be applied both for a transmission diversity system OL-CL located in a base station NB for downlink transmission to a mobile station MS or in the other hand for a mobile station MS which transmits wireless data information to the base station NB.

The main advantage of the current invention is that a significant radio link performance gain is achieved which is almost independent of the receiver station speed. Also, compared to proposed “open-loop” transmission diversity algorithms for four transmission antenna elements, the gain is significantly increased. And, in comparison with other proposed algorithms for “closed-loop” diversity for four transmission antenna elements the gain for medium and high speeds of the mobile station is much higher and the gain is almost stable over the whole speed range.

It shall be further mentioned that, although the above described example is a preferred embodiment of the invention, other antenna arrangements can be used. An example of an alternative antenna arrangement, where the present invention can be beneficially applied, is a pure “diversity” antenna arrangement as shown in FIG. 1A. A useful application is e.g. when the mobile station speed is known to be low, e.g. in a pedestrian area.

1. A transmitting diversity system for wireless transmission of information to a receiver station comprising antenna means composed of at least two antenna groups, and each group consisting of at least two antennas; receiving means for receiving feedback information from the receiver station using a feedback channel for intra antenna group control, and control means for controlling a phase and/or amplitude of a signal transmitted by the antenna means based on said feedback information further comprising an open-loop transmission diversity encoder for encoding of the signal to be transmitted to the receiver station by every antenna group.

2. The transmitting diversity system of claim 1 characterized in that the encoder is a Space Time Transmission Diversity encoder.

3. The transmitting diversity system of claim 1 characterized in that the control means for controlling a phase and/or amplitude of a signal transmitted by the antennas of an antenna group based on the receiver station feedback information is that of Closed Loop Mode 1 or Closed Loop Mode 2.

4. The transmitting diversity system of claim 1 characterized in that the antenna means have a space diversity configuration, where the antenna groups and the antennas of each group are separated determined distances apart from one another so that fading correlation between the antenna groups is low and fading correlation between the antennas is high.

5. The transmitting diversity system of claim 1 characterized in that the antenna means have a cross-polarized configuration, where the antenna groups are orientated a determined angle apart from one another so that fading correlation between the antenna groups is low and the antennas of each group are separated a determined distance from one another so that fading correlation between the antennas is high.

6. The transmitting diversity system of claim 1 characterized in that it is specificly implemented for a four transmission antenna scheme with two groups of antennas SA1 and SA2, comprising two antennas each.

7. A method for wireless transmission of a signal to a receiver station by means of a transmitting diversity system having at least four antennas, the antennas arranged in groups, comprising the steps of:
encoding a signal to be transmitted by means of an open-loop diversity encoder.
transmitting the encoded signals which come out of the encoder by means of antenna groups using a closed-loop beam-forming technique.

8. A base station comprising a transmitting diversity system for wireless transmission of information to a receiver station comprising antenna means composed of at least two antenna groups, and each group consisting of at least two antennas; receiving means for receiving feedback information from the receiver station using a feedback channel for intra antenna group control, and control means for controlling a phase and/or amplitude of a signal transmitted by the antenna means based on said feedback information further comprising an open-loop transmission diversity encoder for encoding of the signal to be transmitted to the receiver station by every antenna group, wherein
the encoder is a Space Time Transmission Diversity encoder,
the control means for controlling a phase and/or amplitude of a signal transmitted by the antennas of an antenna group based on the receiver station feedback information is that of Closed Loop Mode 1 or Closed Loop Mode 2,
the antenna means have a space diversity configuration, where the antenna groups and the antennas of each group are separated determined distances apart from one another so that fading correlation between the antenna groups is low and fading correlation between the antennas is high,
the antenna means have a cross-polarized configuration, where the antenna groups are orientated a determined angle apart from one another so that fading correlation between the antenna groups is low and the antennas of each group are separated a determined distance from one another so that fading correlation between the antennas is high,
wherein it is specificly implemented for a four transmission antenna scheme with two groups of antennas SA1 and SA2, comprising two antennas each.

9. A mobile station comprising a transmitting diversity system for wireless transmission of information to a receiver station comprising antenna means composed of at least two antenna groups, and each group consisting of at least two antennas; receiving means for receiving feedback information from the receiver station using a feedback channel for intra antenna group control, and control means for controlling a phase and/or amplitude of a signal transmitted by the antenna means based on said feedback information further comprising an open-loop transmission diversity encoder for encoding of the signal to be transmitted to the receiver station by every antenna group, wherein
the encoder is a Space Time Transmission Diversity encoder,
the control means for controlling a phase and/or amplitude of a signal transmitted by the antennas of an antenna group based on the receiver station feedback information is that of Closed Loop Mode 1 or Closed Loop Mode 2,
the antenna means have a space diversity configuration, where the antenna groups and the antennas of each group are separated determined distances apart from one another so that fading correlation between the antenna groups is low and fading correlation between the antennas is high,
the antenna means have a cross-polarized configuration, where the antenna groups are orientated a determined angle apart from one another so that fading correlation between the antenna groups is low and the antennas of each group are separated a determined distance from one another so that fading correlation between the antennas is high,
wherein it is specificly implemented for a four transmission antenna scheme with two groups of antennas SA1 and SA2, comprising two antennas each.
